(19) United States
(12) Patent Application Publication
(10) Pub. No.: US 2019/0136111 A1
(43) Pub. Date: May 9, 2019

(54) COMPOSITION FOR DRILLING FLUID AND METHOD OF DRILLING A BOREHOLE

(71) Applicant: ProAction Fluids LLC, Shreveport, LA (US)

(72) Inventors: Nathan R. Hutchings, Shreveport, LA (US); Paxton Monsour, Shreveport, LA (US); Ryan Humphrey, Shreveport, LA (US)

(21) Appl. No.: 16/178,997

(22) Filed: Nov. 2, 2018

Related U.S. Application Data
(60) Provisional application No. 62/582,995, filed on Nov. 8, 2017.
(60) Provisional application No. 62/608,425, filed on Dec. 20, 2017.
(60) Provisional application No. 62/633,862, filed on Feb. 22, 2018.

(51) Int. Cl. C09K 8/20; C09K 8/24; C09K 8/14

(52) U.S. Cl. CPC C09K 8/206; C09K 8/145; C09K 8/24

(57) ABSTRACT

A drilling fluid composition comprises a concentrated mixture of mud additives. The concentrate comprises a water-based suspension medium comprising a colloidal solid and an effective amount of a water-sequestering polymer and an effective amount of at least one drilling mud additive mixed into the water-based suspension medium.

### CROSS REFERENCE TO RELATED APPLICATIONS

Priority is claimed from U.S. Provisional Application No. 62/633,862 filed on Feb. 22, 2018, U.S. Provisional Application No. 62/608,425 filed on Dec. 20, 2017 and U.S. Provisional Application No. 62/582,995 filed on Nov. 8, 2017 all of which are incorporated herein by reference in their entirety.

### STATEMENT REGARDING FEDERALLY SPONSORED RESEARCH OR DEVELOPMENT

Not Applicable

### NAMES OF THE PARTIES TO A JOINT RESEARCH AGREEMENT

Not Applicable.

### BACKGROUND

This disclosure relates to the field of drilling boreholes under features on the Earth's surface. More particularly, the disclosure relates to compositions for drilling fluid used to drill boreholes in permeable, unconsolidated earthen formations near the surface.

Horizontal directional drilling (HDD), also known as trenchless boring or directional boring uses fluids (aka “mud”) to stabilize the borehole, carry cuttings out of the borehole, prevent fluid loss to the exposed formations penetrated while drilling the borehole, cool and lubricate the drill tooling, and prevent debris build up on the drill tooling. It is known in the art to use a combination of bentonite (sodium montmorillonite/smectite, e.g., swelling clay), surfactants, lubricants and polymers for the mud used to drill such boreholes. Some borehole drilling operations use only water (without chemicals) to drill such bores but often experience issues with bore stability and drilling inefficiency when only using water. The specific composition of the mud and rheological properties of the mud required in any particular drilling operation can vary widely based on specific subsurface soil conditions through which the drilling takes place as well as the size of the borehole being created.

Particularly in highly permeable and high bulk-density soils such as sand, sandy loam, loamy sand, sandy clay, and sandy-clay loam (with >50% sand/gravel content), an appropriately designed drilling fluid with moderate low-end rheology (yield point >5 and gel strength >3 as measured in a FANN35 rotational viscometer) substantially improves drilling efficiency and borehole stability.

Drillers typically generate their own preferred mixture of individual ingredients, for example powdered polymers and clays along with liquid surfactants and lubricants mixed with water but generally without any means to assess the rheology of the mixture prior to starting drilling a borehole. An inappropriate mud composition for particular soil types and drilling conditions can result in significantly increased costs and undesirable outcomes (e.g., frac-outs, lost bores, damaged products, and/or road breaches). Furthermore, in contrast to an all-liquid mud additive mixture, handling powdered constituents is logistically difficult and more expensive due to the amount of material required, may be dangerous to personnel (e.g., by risk of inhalation resulting in silicosis, mesothelioma, and other respiratory damage as indicated in the SDS sheets of most of the powdered materials) and difficult to keep the surface area near the drilling unit clean because of wind-blown powder landing on hard to clean equipment surfaces and on the ground. Thus, an all-liquid, pre-measured composite drilling fluid would have performance, economic, and safety advantages over the conventional mix-your-own powder systems.

Because most HDD boreholes are in the O through C Soil Strata (organic layer—parent rock), which are also in continuous contact with ground water, it is desirable that any liquid solvents are environmentally safe (in contrast to hydrocarbon-based, surfactant-laden solvent systems). Most, if not all, commercially available liquid viscosity modifying suspensions (e.g. xanthan gum slurry, or guar gum slurry) are comprised of a base-oil mixed with (a single) powdered polymer containing surfactants and suspension aids (e.g., organophillic clay). When viscosity modifying polymers commonly mixed into drilling fluids, such as guar, xanthan, CMC, PAC, HPAM, PAM, and cellulose-derivatives, come into contact with water the polymers hydrate, swell rapidly, and become extremely viscous. Furthermore, the polar/water soluble ancillary additives (non-viscosifiers) like surfactants, clay stabilizers, water softening chemicals, pH modifiers and the like cannot be co-combined into an oil-based polymer slurry as they (a) are not miscible in oil-based emulsions at relevant concentrations and (b) at relevant concentrations will destabilize the fragile oil-based polymer suspensions. It is therefore very difficult to make water-based, heterogeneous suspensions of sufficiently high polymer and ancillary additive concentrations due to the inability to prevent/control the hydration rate of powdered polymers and solubility of the ancillary additives as they come into contact with water.

### DETAILED DESCRIPTION

Wellbore fluids, e.g., drilling fluid, according to the present disclosure may comprise a water-based suspension medium that serves as a ‘universal’ carrier fluid for heterogeneous mixtures of various dry-powder additives. When the dry powder additives are mixed with the water-based suspension medium in specific ratios, the resulting fluid will form an all-in-one, conveniently premeasured drilling fluid system. Purposes of a drilling fluid composition according to the present disclosure may include the following: (1) to facilitate removal of the loosened soil material away from the borehole annulus, (2) to create a hydraulic seal to permeable earth around the borehole to prevent drilling fluid loss into the soil matrix surrounding the borehole, and (3) to reduce torque, drag, vibration and temperature on the drill pipe and tooling assembly by reducing friction between the tools/pipe and the soil matrix.

The water-based suspension medium may comprise a colloidal solid, such as 0.5 to 4% (by weight, “wt %”) sodium bentonite and at least one highly soluble water-sequestering polymer, such as 0.01 to 0.5 wt % polyacrylic acid (or sodium polyacrylate) and/or 35 to 60 wt % polyether/polyethylene oxide, e.g., poly-ethylene glycol (PEG). The water-based suspension medium may be made by first dispersing the colloidal solid (e.g., bentonite) in water until a substantially homogenous mixture is formed, and then directly adding the water-sequestering polymer(s) (PA/PEG pellets and/or powder) to the dispersed bentonite mixture. The foregoing components should be gently mixed to avoid excessive aeration and/or foaming until all of the water-sequestering polymer is dissolved in the water phase of the water-based suspension and the mixture is substantially homogenous. Such a suspension medium can be stored for extended periods and may be used as the suspension medium for multiple combinations of dry mud additives. The total concentration of water-sequestering polymer(s) in the mixture should be sufficiently high (generally greater than 20 wt %) to prevent over-hydration of mud additives subsequently introduced into the mixture such that the resulting mud-additive mixture can be packaged and stored as a stable liquid slurry or paste (e.g. the mixture does not continue to increase in viscosity as a result of over-hydration of the mud additives after the mixture is initially made). Furthermore, the concentrations of the mud additives in the concentrated pre-mix must be sufficiently high to enable convenient handling and dosing into mud tanks or hoppers. Generally, the rheological mud additives should range from 20% to 60 wt % of the final (concentrated) mixture, and the ancillary additives will generally range from 0.5% to 20 wt %. The concentrated pre-mix may then be dosed in the range of 0.1% to 5% (by volume or weight) into mud mixing tanks.

The desirable components of an effective mud system for various soil conditions can be combined into the suspension medium to create particular “all-in-one” mud-mix concentrates. For example, an all-in-one water-based suspension can be pre-made and packaged by combining the suspension medium with anionic PHPA (clay flocculent, viscosifier, and friction reducer), sodium tripolyphosphate (non-foaming detergent builder) and choline chloride (clay stabilizer) for use as a drilling fluid in soils containing greater than 20% clay. In another example, an all-in-one water-based suspension can be pre-made and packaged by combining the suspension medium with guar gum, xanthan gum, bentonite, and poly-anionic cellulose (PAC) to comprise a single-additive drilling fluid in soils containing more than 30% sand and/or other relatively high-density particles not susceptible to swelling. The very large number of pre-made mixes that can be “pre-combined”using this technique will be apparent to those skilled in the art of drilling mud compositions and mixing methods.

Common drilling mud additives to mix into the suspension medium for various all-in-one mixes may include, but would not necessarily be limited to, combinations of: bentonite (including high-yield or other modified clay-based mud powders), xanthan gum, guar gum, poly-anionic cellulose, other modified cellulose derivatives, polyacrylamides, 2-acrylamido-2-methylpropane sulfonate (AMPS), partially hydrolyzed polyacrylamide (HPAM, PHPA), sodium polyacrylate polymers, acrylamide/sodium acrylate copolymer (e.g. 2-Propenamide polymer), and/or PHPA/AMPS co-polymers, non-ionic detergents, foaming detergents, defoamers, clay stabilizers (e.g. choline chloride, tetra-methyl ammonium chloride (TMAC) and the like), flocculants, de-flocculants, dispersants, lost circulation material (including calcium carbonate, polyester or other synthetic fibers or natural fibers from bulk plant matter like coconut or peanut shells), pH modifiers and buffers, water conditioning agents, and other commonly known dry-mix mud additives.

The ratio of each specific additive may be modified in the suspension depending on the target soil conditions to which the mixture is be applied for drilling; however, one embodiment of a pre-measured all-in-one drilling fluid mixture comprises, by weight percent:

| | |
|---|---|
| Suspension medium (1% bentonite, .0025% | 60 wt % |
| polyacrylate, 50% PEG1450) | |
| Xanthan Gum powder | 20 wt % |
| Guar Gum powder | 10 wt % |
| Poly-Anionic Cellulose (PAC-R) powder | 5 wt % |
| Anionic HPAM/PHPA powder | 5 wt % |

The foregoing concentrated mixture (40% by weight of additives) can be added to water at a boring site at a ratio of 1 to 5 gallons per 500 gallons (0.2%-1% v/v) to form an effective drilling fluid with a plastic viscosity >15, yield point >5, and gel strength >3. Depending on the target soil conditions, the variations within the indicated range of ingredients may be used in the mixture to target different rheological properties. Other water-sequestering polymers (such as dextran-based polymers for example) may be substituted for or blended with the PEG as part of the suspension medium. The molecular weight range of the PEG may be from 200-20K g/mol. The amount of PEG in the suspension medium can range between 30 wt % to 65 wt % depending on the powder mixture composition and desired suspension properties. The amount of bentonite in the suspension medium can range from 0.5 to 10 wt % depending on the powder mixture composition and desired suspension properties.

It will be appreciated by those skilled in the art that the addition of small amounts of surfactant in powder or liquid form, or powdered lubricant (e.g., graphic, lecithin), anti-caking agents (e.g. silicates), foamer or defoamer, additional colloidal suspension aides, or biological control agents (preservatives, biocides, e.g. sodium benzoate) would be reasonable to include in the water-based medium so long as the additives do not cause the rheology-modifying polymers to prematurely hydrate in the concentrated mixture.

The same or similar mixtures may be appropriately used in hydrocarbon extraction well construction as drilling additives and/or completion fluids.

Although only a few examples have been described in detail above, those skilled in the art will readily appreciate that many modifications are possible in the examples. Accordingly, all such modifications are intended to be included within the scope of this disclosure as defined in the following claims.

What is claimed is:

1. A drilling fluid composition comprising a concentrate, the concentrate comprising:
a water-based suspension medium comprising a colloidal solid and an effective amount of a water-sequestering polymer; and
an effective amount of at least one drilling mud additive mixed into the water-based suspension medium.

2. The composition of claim 1 wherein the colloidal solid comprises bentonite.

3. The composition of claim 1 wherein the water-sequestering polymer comprises polyacrylic acid, polyether/polyethylene oxide and mixtures thereof.

4. The composition of claim 1 wherein the at least one drilling mud additive comprises at least one of a clay flocculent, a viscosifier, and a friction reducer.

5. The composition of claim 1 wherein the at least one drilling mud additive comprises at least one of a detergent and a clay stabilizer.

6. The composition of claim 1 wherein the concentrate further comprises at least one mud additive which may include one or more of the following: bentonite (including high-yield or other modified clay-based mud powders), xanthan gum, guar gum, poly-anionic cellulose, other modified cellulose derivatives, polyacrylamides, 2-acrylamido-2-methylpropane sulfonate (AMPS), partially hydrolyzed polyacrylamide (HPAM, PHPA), sodium polyacrylate polymers, acrylamide/sodium acrylate copolymer (e.g. 2-Propenamide polymer), and/or PHPA/AMPS co-polymers, non-ionic detergents, foaming detergents, defoamers, clay stabilizers (e.g. choline chloride, tetra-methyl ammonium chloride (TMAC) and the like), flocculants, de-flocculants, dispersants, lost circulation material (including calcium carbonate, polyester or other synthetic fibers or natural fibers from bulk plant matter like coconut or peanut shells), pH modifiers and buffers, water conditioning agents.

7. The composition of claim 1 wherein the concentrate is mixed in water in a volume fraction of 0.2% to 5% concentrate to water to form a drilling fluid.

8. A method for making a drilling mud composition, comprising forming a concentrate by:
mixing a colloidal solid in water;
adding an effective amount of a water-sequestering polymer to the colloidal solid mixed in the water to produce a water-based suspension medium; and
mixing an effective amount of at least one drilling mud additive to a water-based suspension medium.

9. The method of claim 8 wherein the colloidal solid comprises bentonite.

10. The method of claim 8 wherein the water-sequestering polymer comprises polyacrylic acid, polyether/polyethylene oxide and mixtures thereof.

11. The method of claim 8 wherein the concentrate further comprises at least one of the following: bentonite (including high-yield or other modified clay-based mud powders), xanthan gum, guar gum, poly-anionic cellulose, other modified cellulose derivatives, polyacrylamides, 2-acrylamido-2-methylpropane sulfonate (AMPS), partially hydrolyzed polyacrylamide (HPAM, PHPA), sodium polyacrylate polymers, acrylamide/sodium acrylate copolymer (e.g. 2-Propenamide polymer), and/or PHPA/AMPS co-polymers, non-ionic detergents, foaming detergents, defoamers, clay stabilizers (e.g. choline chloride, tetra-methyl ammonium chloride (TMAC) and the like), flocculants, de-flocculants, dispersants, lost circulation material (including calcium carbonate, polyester or other synthetic fibers or natural fibers from bulk plant matter like coconut or peanut shells), pH modifiers and buffers, water conditioning agents.

12. The method of claim 8 wherein the concentrate is mixed in water in a volume fraction of 0.2% to 5% concentrate to water to form a drilling fluid.
